(19) United States
(12) Patent Application Publication
(10) Pub. No.: US 2014/0105515 A1
(43) Pub. Date: Apr. 17, 2014

(54) Stabilizing and Deblurring Atmospheric Turbulence

(71) Applicant: The Regents of the University of California, Oakland, CA (US)

(72) Inventors: Xiang Zhu, San Jose, CA (US); Peyman Milanfar, Menlo Park, CA (US)

(21) Appl. No.: 14/108,083

(22) Filed: Dec. 16, 2013

Related U.S. Application Data
(63) Continuation-in-part of application No. 13/856,977, filed on Apr. 4, 2013, now abandoned.
(60) Provisional application No. 61/620,185, filed on Apr. 4, 2012.

(51) Int. Cl. G06T 5/00

(52) U.S. Cl. CPC G06T 5/00
USPC 382/254

(57) ABSTRACT

A method for image restoration and reconstruction registers each frame of an observed image sequence to suppress geometric deformation through B-spline based non-rigid registration, producing a registered sequence, then performs a temporal regression process on the registered sequence to produce a near-diffraction-limited image, and performs a single-image blind deconvolution of thenear-diffraction-limited image to deblur it, generating a final output image.

### CROSS-REFERENCE TO RELATED APPLICATIONS

This application is a continuation-in-part of U.S. patent application Ser. No. 13/856977 filed Apr. 4, 2013, which claims priority from U.S. Provisional Patent Application 61/620185 filed Apr. 4, 2012, both of which are incorporated herein by reference.

### STATEMENT OF GOVERNMENT SPONSORED SUPPORT

This invention was made with Government support under contract CCF-1016018 awarded by National Science Foundation, and under contract FA9550-07-1-0365 awarded by Air Force Office of Scientific Research. The Government has certain rights in this invention.

### FIELD OF THE INVENTION

The present invention relates generally to methods for video and image processing. More specifically, it relates to image restoration and reconstruction techniques.

### BACKGROUND OF THE INVENTION

Atmospheric imaging turbulence caused by variation of refractive index along the optical transmission path can strongly affect the performance of a long-distance imaging system. It produces geometric distortion, space-and-time-variant defocus blur, and motion blur (if the exposure time is not sufficiently short).

Existing restoration algorithms for this problem can generally be divided into two main categories. The first is based on a multi-frame reconstruction framework and the other is known as “lucky exposure”. The main problem with multi-frame reconstruction algorithms is that in general they cannot accurately estimate the actual point spread function (PSF), which is spatially and temporally changing, hence limiting their performance. The “lucky exposure” approach employs image selection and fusion methods to reduce the blurring effects caused by turbulence. One shortcoming of this method is that even though turbulence caused blur is strongly alleviated through the fusion process, the output still suffers from blur caused by diffraction-limited PSF.

### SUMMARY OF THE INVENTION

Accordingly, an embodiment of the present invention provides a method for restoring a single image from an image sequence acquired in anisoplanatic (i.e., air turbulence) scenarios. The method is designed to reduce the spatial variation of PSFs over the whole image space through a non-parametric kernel regression algorithm, so that the blur can be approximately treated as spatially invariant, and the latent image content is then estimated globally. The method is capable of alleviating geometric deformation and space-and-time-varying blur caused by turbulence, recovering details of the scene and significantly improving the visual quality.

### BRIEF DESCRIPTION OF THE DRAWINGS

FIG. 1 illustrates an overview of a method according to an embodiment of the invention.

### DETAILED DESCRIPTION

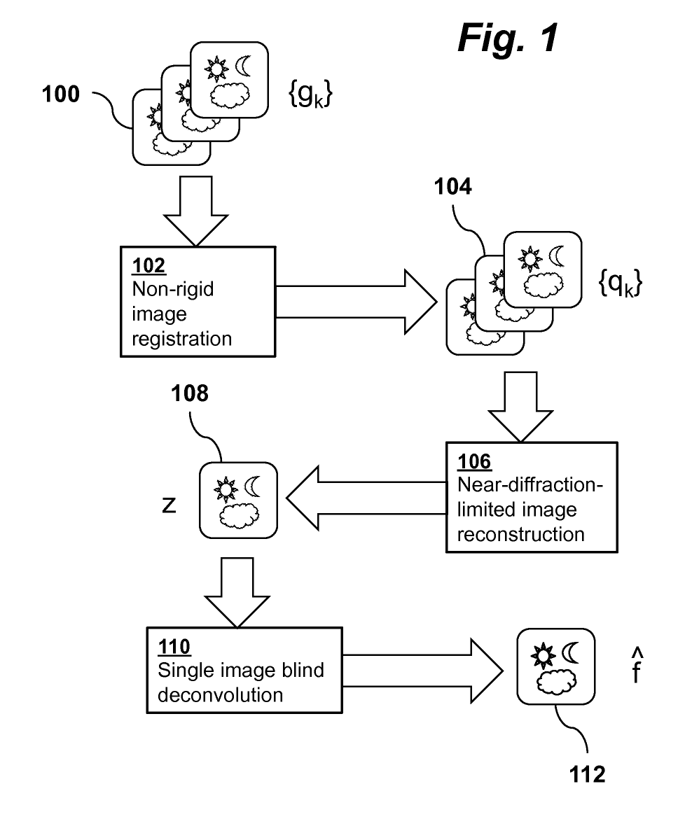

An overview of an embodiment of the method is illustrated in FIG. 1. An observed sequence of digital images {gₖ} 100 is collected and stored on a computer system. The images {gₖ} may have undesired distortion and blur due to atmospheric turbulence between the camera and the object. In step 102 each frame of an observed sequence of images {gₖ} 100 is registered to suppress geometric deformation through B-spline based non-rigid registration, producing a registered sequence {qₖ} 104. Next, in step 106, a temporal regression (fusion) process is carried out on the registered sequence {qₖ} to produce an image z 108 from the registered frames, which can be viewed as being convolved with a space-invariant near-diffraction-limited blur. Finally, in step 110, a blind deconvolution algorithm is implemented to deblur the fused image, generating a final output image \hat{f}, 112.

The techniques of the present invention may be implemented, for example, as an image restoration and reconstruction computer system for processing image data input to the system or stored by the system, where the image data have geometric distortion and space and time-variant blur due to atmospheric turbulence. The present invention may also be realized as a digital storage medium tangibly embodying machine-readable instructions executable by a computer, where the instructions implement the techniques of the invention described herein to perform image restoration and reconstruction.

In one aspect, the invention provides a method for restoring a single image from an image sequence acquired in aniso-planatic scenarios. The 3-D physical scene is assumed to be static, while the air between the scene and sensor is affected by atmospheric turbulence. The approach is designed to reduce the space and time-variant deblurring problem to a shift invariant problem. It focuses on the observed regions convolved by near-diffraction-limited PSFs, which can be viewed as space and time-invariant, and thus can be estimated along with the latent sharp image through a blind deconvolution algorithm. This framework is capable of alleviating both geometric deformation and blur, and significantly improving the visual quality.

The imaging process can be modeled as

gₖ=HₖFₖf+nₖ (1)

where gₖ represents the k-th observed image frame, f denotes the (unknown) ideal image, Fₖ represents the geometric deformation matrix, Hₖ represents the blurring matrix, and nₖ represents additive noise (which is defined as zero mean and i.i.d). The image reconstruction problem is to estimate the ideal image f based on the observed image data gₖ.

In some prior approaches to this reconstruction problem, specific models (e.g., Gaussian) are used to describe the shape of local PSFs caused by air turbulence, but these do not fit practical cases very well. In the real world, while turbulence-caused PSFs can look quite arbitrary, they still have some common characteristics. For example, usually they are restricted within a small region, and contain a “core,” which is the peak intensity of a PSF. In the above model, since geometric distortion is separated from the blurring matrix, the core of each local PSF (also the entry with highest value in each row) is typically located on the diagonal of Hₖ.

To estimate the latent image f, a new restoration framework is provided, which contains three main steps, as outlined in FIG. 1:

1. Non-rigid image registration (step 102).

2. Fusion-based near-diffraction-limited image restoration (step 106).

3. Single image blind deconvolution (step 110).

The first step 102 registers each frame onto a fixed reference grid, removing geometric distortion from the observed data. The second step 106 fuses the registered sequence to produce a single image convolved by near-diffraction-limited PSFs, which have short support and can be approximately viewed as spatially invariant. The fused image is finally deconvolved in the third step 110 through a blind deblurring algorithm based on a natural image prior. Details about each step are given in the following subsections.

Non-Rigid Image Registration

Assuming that the local turbulent motion has a zero-mean distribution, the geometric distortion can be removed by simply averaging the observed frames. Such averaged image, though even more blurred than the observed data, can serve as a reference frame to register each observed frame. A B-spline based non-rigid registration method may be directly implemented in the approach. For example, in prior work by the present inventors, such a B-spline based non-rigid registration method is disclosed in the article “Image reconstruction from videos distorted by atmospheric turbulence,” In SPIE Electronic Imaging, Conference 7543 on Visual Information Processing and Communication, San Jose, Calif., January 2010. This method incorporates a symmetry constraint that can effectively improve the estimation accuracy.

The techniques of the present invention are related to the question of how the registration operator physically changes local PSFs. Assume that the warping matrix Fₖ is non-singular. The registration operator can then be denoted as Fₖ⁻¹. Left-multiplying both sides of eq. 1 by Fₖ⁻¹ we have

qₖ=\tilde{H}ₖf+ñₖ (2)

where

\tilde{H}ₖ=Fₖ⁻¹HₖFₖ (3)

ñₖ=Fₖ⁻¹nₖ

and where

qₖ=Fₖ⁻¹gₖ

is the registered image.

The blurring matrices \tilde{H}ₖ and Hₖ are related by a similarity transformation. Since a similarity transformation preserves the spectrum (eigenvalues) of Hₖ, the transformation should not significantly change the physical shape of PSFs. In particular, if the motion is pure translational and applies only integer movement (pixel to pixel), then Fₖ is a block-circulant matrix with each row and column containing precisely a single 1 and with 0 s everywhere else. That is, we can approximate Fₖ by a permutation matrix, which means that Fₖ^{T}=Fₖ⁻¹. For such matrices, the corresponding similarity transformation circulates the rows and columns of Hₖ. In other words, the registration operator only moves the locations of local PSFs without changing their physical shape. Of course the overall motion caused by turbulence is not translational. However, the local motion inside an iso-planatic region can be well-approximated as translational. If the support of any local PSF is also small enough, then inside an isoplanatic region the transformation Fₖ⁻¹HₖFₖ preserves the physical shape of local PSF. Meanwhile, it can be shown that the diagonal entries of Hₖ still remain on the diagonal of Hₖ with their locations permutated. Furthermore, since Fₖ can be approximated as a permutation matrix (pixel to pixel movement) we can also write:

cov(ñₖ)=Fₖ⁻¹cov(nₖ)Fₖ≈σₙ²I (4)

Near-Diffraction Limited Image Restoration

By decomposing the overall blur \tilde{H}ₖ=H+Δ\tilde{H}ₖ, equation (2) can be rewritten as

$$\begin{matrix}{q}_{k} = ( H + Δ {\tilde{H}}_{k} ) f + {\tilde{n}}_{k} \\ = Hf + Δ {\tilde{H}}_{k} f + {\tilde{n}}_{k} \\ = z + {e}_{k} + {\tilde{n}}_{k}\end{matrix} \qquad ( 5 )$$

where H is diffraction-limited blur and z=Hf denotes the diffraction-limited image. The matrix Δ\tilde{H}ₖ represents turbulence-caused blur, and eₖ=Δ\tilde{H}ₖf is the corresponding blurring artifact. The diffraction-limited blur is not a priori known, but is assumed to be space and time invariant, and there are numerous blind deconvolution algorithms available for removing it. Estimating Δ\tilde{H}ₖ, on the other hand, is not trivial. However, if we treat eₖ as an additive noise, then it is still possible to estimate the diffraction-limited image z. This requires an analysis of the statistical properties of eₖ, which we present next.

Both \tilde{H}ₖ and H can be viewed as row-stochastic (i.e., each row consists of non-negative real numbers that sum up to 1), which means \tilde{h}ᵢ^{T}1=hᵢ^{T}1=1, and thus

Δ\tilde{h}ᵢ^{T}1=(\tilde{h}ᵢ−hᵢ)^{T}1=0 (6)

Here Δ\tilde{h}ᵢ^{T}, \tilde{h}ᵢ^{T}, and hᵢT represent the i-th rows of matrices Δ\tilde{H}ₖ, \tilde{H}ₖ, and H, respectively. Because the support of the PSFs \tilde{h}ᵢ and hᵢ are restricted to a small isoplanatic region around the i-th pixel denoted as wᵢ, all the non-zero values of Δ\tilde{h}ᵢ should also be located inside wᵢ:

Δhᵢⱼ=0, ∀j∉ᵢ (7)

where Δ\tilde{h}ᵢⱼ represents the j-th element of vector Δ\check{h}ᵢ. By defining a diagonal matrix Mᵢ denoting a mask having 1 s in the locations inside wᵢ and 0 s everywhere else, we have MᵢΔ\tilde{h}ᵢ=Δ\tilde{h}ᵢ.

We model the latent sharp image f as a random field whose mean vector is

m_{f}=[m_{f1}, m_{f2}, . . . ]⁹,

and its covariance matrix is assumed to be diagonal

C_{f}=diag[σ²_{f1}, σ²_{f2}, . . . ].

The statistics of f are considered piece-wise stationary:

m_{fj}≈m_{fi}, σ²_{fj}≈σ²_{fi}∀j∈wᵢ (8)

and thus

Mᵢm_{f}≈m_{fi}Mᵢ1 (9)

So considering eq. 6-9, we have:

$$\begin{matrix}Δ {\tilde{h}}_{i}^{T} {m}_{f} = {( {M}_{i} Δ {\tilde{h}}_{i} )}^{T} {m}_{f} \\ = {m}_{fi} Δ {\tilde{h}}_{i}^{T} {M}_{i} 1 \\ = 0\end{matrix} \qquad ( 10 )$$

which indicates that the mean of eₖ is zero. Now we have zero-mean additive noise eₖ, whose covariance matrix is Cₑ_{ₖ}=Δ\tilde{H}ₖC_{f}Δ\tilde{H}ₖT with diagonal entries

σ²ₑ_{ₖ}ᵢ=Σⱼσ²_{fj}Δ\tilde{h}ᵢⱼ² (11)

Again, by applying eq. 7 and 8 the above entries can be written as:

σ²ₑ_{ₖ}ᵢ=σ²_{fi}∥Δ\tilde{h}ᵢ∥² (11)

Combining the additive noise ñₖ and eₖ together we define the total additive noise

εₖ=ñₖ+eₖ (13)

Since ñₖ and eₖ are independent, the covariance matrix of εₖ becomes Cₖ=Cₑ_{ₖ}+σ²ₙI. Then the diffraction-limited image z can be estimated through:

\hat{z}=arg min_{z}Σₖ(qₖ−z)^{T}Cₖ⁻¹(qₖ−z) (14)

For simplicity, we only take the diagonal part of Cₖ denoted as Uₖ=diag[uₖ₁, uₖ₂, . . . ], whose i-th diagonal entry can be written as:

uₖᵢ=σ²ₙ+σ²_{fi}∥Δ\tilde{h}ᵢ∥² (15)

Now the estimation problem in eq. 14 can be simplified as:

$$\begin{matrix}\hat{z} = arg {min}_{z} {{Σ}_{k} ( {q}_{k} - z )}^{T} {U}_{k}^{- 1} ( {q}_{k} - z ) \\ = {( {Σ}_{k} {U}_{k}^{- 1} )}^{- 1} {Σ}_{k} {U}_{k}^{- 1} {q}_{k}\end{matrix} \qquad ( 16 )$$

Or in pixel-wise form:

\hat{z}ᵢ=(Σₖuₖᵢ⁻¹qₖᵢ)(Σₖuₖᵢ⁻¹)⁻¹ (17)

which may be interpreted as an image fusion process, where the weight value uₖᵢ⁻¹ is determined by σ²ₙ and σ²_{fi}∥Δhᵢ∥². If σ²ₙ is temporarily constant, then a larger value of σ²_{fi}∥Δ\tilde{h}ᵢ∥² (i.e., more blurry) corresponds ponds to a smaller value of uₖᵢ⁻¹ (i.e., lower weight).

In practice, noise variance σ²ₙ is viewed as spatially invariant and can be estimated using, for example, median absolute deviation (MAD) method.

Once sufficient observations are collected, diffraction-limited image patches (also the sharpest isoplanatic patches) that occasionally appear due to the turbulence variation can be detected through known sharpness metrics such as Strehl ratio, image gradient, or local intensity variance. These diffraction-limited patches suffer from noise and cannot be used directly as outputs since noise will be magnified in the following deconvolution step. However, they can be utilized as references for calculating the local variances of eₖ and the weights (15) for the fusion. Let us consider a given isoplanatic region wᵢ centered at the i-th pixel across all the registered frames. Assume that the sharpest patch of wᵢ, which can be approximated as a diffraction-limited patch, is detected in the k′-th frame:

Mᵢq_{k′}=MᵢHf+Mᵢn_{k′}. (18)

Then, given the k-th frame we can write the patch difference:

Mᵢ(qₖ−q_{k′})=MᵢΔ\tilde{H}ₖf−Mᵢn_{k′}+Mᵢnₖ (19)

Because of the isoplanaticism of local PSF, and of the piecewise constancy of image variance, it can be deduced that:

$$\begin{matrix}var [ {M}_{i} ( {q}_{k} - {q}_{{k}^{′}} ) ] = ( 1 \text{/} \vert {w}_{i} \vert ) tr \{ {M}_{i} Δ {\tilde{H}}_{k} {C}_{f} Δ {\tilde{H}}_{k}^{T} {M}_{i} + 2 {σ}_{n}^{2} {M}_{i}^{2} \} \\ = ( 1 \text{/} \vert {w}_{i} \vert ) tr \{ {C}_{f} Δ {\tilde{H}}_{k}^{T} {M}_{i} {M}_{i} Δ {\tilde{H}}_{k} \} + 2 {σ}_{n}^{2} \\ \approx {σ}_{fi}^{2} {‖ Δ {\tilde{h}}_{i} ‖}^{2} + 2 {σ}_{n}^{2}\end{matrix} \qquad ( 20 )$$

where |wᵢ| is the cardinality of the set wᵢ. Thus the weight-related value uₖᵢ in eq. 15 can be approximated by

uₖᵢ=var[Mᵢ(qₖ−q_{k′})]−σ²ₙ (21)

It is worth noting that due to the covariance matrix simplification in eq. 16 and the limited registration accuracy, the PSF of the fused image is, in practice, not the pure diffraction-limited PSF. Namely, it includes diffraction-limited blur, residual turbulence blur, and blur caused by registration error. So we call such PSF near-diffraction limited. Because the fusion process strongly reduces the PSF variation, such PSF can be approximately viewed as spatially invariant.

A concise description of the algorithm for the near-diffraction-limited image restoration step is as follows:

Procedure for Restoring A Diffraction-Limited Image from Registered Frames

1. Given a registered frame sequence {qₖ}, divide each frame into N×N overlapping patches centered at each pixel, and calculate the variance of each patch as a local sharpness measure.

2. For patches centered at the i-th position across all the frames, find the sharpest patch, say in frame k′, as the diffraction-limited reference.

3. Set u_{k′i}=σ²ₙ, and for the remaining patches in frame k≠k′ use eq. 21 to calculate uₖᵢ.

4. Restore the i-th pixel according to the regression form eq. 17.

5. Go to the (i+1)-th pixel and return to step 2.

Single Image Blind Deconvolution Finally, the unknown image f and the near-diffraction-limited PSF h (which is the vector form of H) can be estimated using a Bayesian image deconvolution algorithm described as:

[symbol]

\hat{f},ĥ [symbol] =arg min_{f,h}{z−HF}+λ₁R_{f}(f)+λ₂Rₕ(h)

where R_{f} and Rₕ are the regularization terms based on prior knowledge about the latent sharp image f and the PSF h. Recent research on natural image statistics has shown that image gradients obey heavy-tailed distributions that have most of the mass on small values but give significantly more probability to large values than Gaussian distributions. Based on these studies, several sparsity-based regularization methods have been introduced and have achieved great success in solving the blind deconvolution problem. One example is disclosed in Q. Shan, J. Jia, and A. Agarwala, “High-quality motion deblurring from a single image,” ACM Transactions on Graphics (SIGGRAPH), 2008. Shan's method may be directly applied in the proposed framework as the final step, using their default parameter settings, except that the noise level parameter ‘noiseStr’ is chosen in the range [0.01, 0.05] according to the actual noise level observed in the given data.

The methods have application, for example, to telescopic optical imaging where at least part of the optical path passes through the atmosphere.

1. A computer-implemented method for image restoration and reconstruction, the method comprising:
storing by a computer an observed image sequence {gₖ},
registering by the computer each frame of the observed image sequence {gₖ} to suppress geometric deformation using a B-spline-based non-rigid registration, producing a registered sequence {qₖ};
performing by the computer a temporal regression process on the registered sequence {qₖ} to produce a near-diffraction-limited image z;
performing by the computer a single-image blind deconvolution of the image z to deblur the image z, generating a final output image \hat{f};
storing by the computer the final output image \hat{f}.

2. The method of claim 1 wherein registering by the computer each frame of the observed image sequence {gₖ} to suppress geometric deformation using a B-spline-based non-rigid registration comprises averaging frames of the observed image sequence {gₖ} to produce a reference frame to register each frame.

3. The method of claim 1 wherein registering by the computer each frame of the observed image sequence {gₖ} comprises computing qₖ=Fₖ⁻¹gₖ , where Fₖ⁻¹ is a registration operator represented by a permutation matrix.

4. The method of claim 1 wherein performing by the computer a temporal regression process on the registered sequence {qₖ} to produce a near-diffraction-limited image z comprises estimating z using an image fusion process using weight values uₖᵢ⁻¹ estimated from the registered images and a spatially invariant noise variance σ²ₙ.

5. The method of claim 1 wherein performing by the computer a temporal regression process on the registered sequence {qₖ} to produce a near-diffraction-limited image z comprises:
(i) dividing each frame of {qₖ} into NxN overlapping patches centered at each pixel, and calculating the variance of each patch as a local sharpness measure;
(ii) for patches centered at the i-th position across all the frames {qₖ}, finding a frame k′ containing the sharpest patch as the diffraction-limited reference;
(iii) setting uₖᵢ=σ²ₙ, and for the remaining patches in frame k≠k′ calculating uₖᵢ;
(iv) restoring the i-th pixel according to a regression form;
(v) repeating steps (ii), (iii), (iv) for additional pixels.

6. The method of claim 1 wherein performing by the computer a single-image blind deconvolution of the image z to deblur the image z, generating a final output image \hat{f}, comprises using a Bayesian image deconvolution algorithm.
